(19) United States
(12) Patent Application Publication
(10) Pub. No.: US 2025/0077906 A1
(43) Pub. Date: Mar. 6, 2025

(54) PHYSICAL PROPERTY INFORMATION RETRIEVAL SYSTEM, PHYSICAL PROPERTY INFORMATION RETRIEVAL METHOD, AND STORAGE MEDIUM STORING PHYSICAL PROPERTY INFORMATION RETRIEVAL PROGRAM

(71) Applicant: Hitachi High-Tech Corporation, Tokyo (JP)

(72) Inventors: Ruriko TSUNETA, Tokyo (JP); Kazuo MUTO, Tokyo (JP)

(21) Appl. No.: 18/738,425

(22) Filed: Jun. 10, 2024

(30) Foreign Application Priority Data
Aug. 28, 2023 (JP) 2023-138368

(51) Int. Cl. G06N 5/022

(52) U.S. Cl. CPC G06N 5/022

(57) ABSTRACT

A substance information database stores physical property case example information in which substance specifying information specifying a substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data. When a transmission and reception unit acquires substance information retrieval condition, a processing unit retrieves the substance information database to acquire substance case example information satisfying the substance information retrieval condition, and causes the transmission and reception unit to output substance case example information satisfying the substance information retrieval condition acquired by the processing unit.

### CROSS-REFERENCE TO RELATED APPLICATION

The present application claims priority from Japanese application JP2023-138368, filed on Aug. 28, 2023, the content of which is hereby incorporated by reference into this application.

### TECHNICAL FIELD

The present invention relates to a physical property information retrieval system including a processor and a storage device that stores a substance information database storing information on a substance, a physical property information retrieval method, and a physical property information retrieval program, in which when a retrieval condition related to the substance is acquired, information satisfying the retrieval condition related to the substance is acquired from the substance information database and the acquired information satisfying the retrieval condition is output.

### BACKGROUND ART

Correct physical property values are important in many cases. For example, in order to design a product so as to secure durability and safety of the product, correct physical property values of the material thereof are required. Further, in Materials Informatics (MI) and Process Informatics (PI), it is indispensable that the physical property values to be used are correct. In Materials Informatics and Process Informatics, it is difficult to obtain an appropriate result unless the physical property values to be used are correct. Materials Informatics is a generic term of attempts to perform efficient and high-speed new material search and trial production by analyzing a database of results of experiments and simulations on materials using an information science (informatics) technique. Process Informatics is a generic term for efficiently searching and optimizing a method of synthesizing and manufacturing materials, such as how to create materials searched by Materials Informatics.

In order to obtain a correct physical property value, it is necessary to acquire measurement data of a substance under appropriate measurement conditions, correctly interpret the measurement data, and correctly calculate the physical property value based on the measurement data. In order to appropriately determine the measurement conditions and interpret the measurement data, measurement data and measurement conditions of a substance measured in the past are often referred to.

There is a technique of efficiently collecting measurement data and measurement conditions of a substance measured in the past, which are referred to for determination of measurement conditions and interpretation of measurement data. For example, Patent Literature 1 discloses a research and development support system that retrieves and outputs information for supporting research and development, from a database that stores digitized experiment data output from a device used in an experiment by a researcher, a chart created based on the experiment data, an idea related to research and development thought up by the researcher, a note related to consideration of an experiment result, and the like.

### CITATION LIST

### Patent Literature

Patent Literature 1: JP2020-52602A

### SUMMARY OF INVENTION

### Technical Problem

However, even when measurement data and measurement conditions of a substance measured in the past, which are referred to for determination of measurement conditions and interpretation of measurement data, are retrieved from the database using the technique disclosed in Patent Literature 1, various types of information other than the measurement data and the measurement conditions of the substance, such as the chart created based on the experiment data, the idea related to research and development thought up by the researcher, and the note related to consideration of the experimental result, are obtained in association with the measurement data and the measurement conditions of the substance in the technique disclosed in Patent Literature 1. Therefore, even when the technique disclosed in Patent Literature 1 is used, there is a problem that it takes time and effort to collect measurement data and measurement conditions of a substance measured in the past, which are referred to for determination of measurement conditions and interpretation of measurement data.

Therefore, an object of the invention is to provide a physical property information retrieval system, a physical property information retrieval method, and a physical property information retrieval program that facilitate collection of information on measurement of a substance measured in the past, which is referred to for determination of measurement conditions and interpretation of measurement data.

### Solution to Problem

In order to achieve the above object, according to an aspect of the invention, there is provided a physical property information retrieval system that includes a processor and a storage device storing a substance information database storing information on a substance and, when a retrieval condition related to the substance is acquired, acquires information satisfying the retrieval condition related to the substance from the substance information database and outputs the acquired information satisfying the retrieval condition, the physical property information retrieval system including: a processing unit; and a transmission and reception unit configured to transmit and receive data. The substance information database stores physical property case example information in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data. When the transmission and reception unit acquires substance information retrieval condition including at least one of the substance specifying information, the measurement data, information included in the information on the measurement condition of the measurement data, information included in the measured physical property value, and information included in the physical property specifying information, the processing unit retrieves the substance information database to acquire substance case example information satisfying the substance information retrieval condition, and causes the transmission and reception unit to output the substance case example information satisfying the substance information retrieval condition acquired by the processing unit.

According to another aspect of the present invention, there is provided a physical property information retrieval method for a physical property information retrieval system that includes a processor and a storage device storing a substance information database storing information on a substance and, when a retrieval condition related to the substance is acquired, acquires information satisfying the retrieval condition related to the substance from the substance information database and outputs the acquired information satisfying the retrieval condition. The substance information database stores physical property case example information in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data. When substance information retrieval condition including at least one of the substance specifying information, the measurement data, information included in the information on the measurement condition of the measurement data, information included in the measured physical property value, and information included in the physical property specifying information is acquired, the processor retrieves the substance information database to acquire substance case example information satisfying the substance information retrieval condition, and outputs the acquired substance case example information satisfying the substance information retrieval condition.

According to another aspect of the present invention, there is provided a physical property information retrieval program in a physical property information retrieval system that includes a processor and a storage device storing a substance information database storing information on a substance and, when a retrieval condition related to the substance is acquired, acquires information satisfying the retrieval condition related to the substance from the substance information database and outputs the acquired information satisfying the retrieval condition. The substance information database stores physical property case example information in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data. When the physical property information retrieval system acquires substance information retrieval condition including at least one of the substance specifying information, the measurement data, information included in the information on the measurement condition of the measurement data, information included in the measured physical property value, and information included in the physical property specifying information, the processor is caused to retrieve the substance information database to acquire substance case example information satisfying the substance information retrieval condition, and output the acquired substance case example information satisfying the substance information retrieval condition.

### Advantageous Effects of Invention

According to a representative aspect of the invention, collection of information on measurement of a substance measured in the past, which is referred to for determination of a measurement condition and interpretation of measurement data, is facilitated.

Problems, configurations, and effects other than those described above will be clarified by descriptions of the following embodiments.

### BRIEF DESCRIPTION OF DRAWINGS

FIG. 1 is a diagram illustrating an example of a functional block diagram of a physical property information retrieval system according to an embodiment.

FIG. 2 is a block diagram illustrating a hardware configuration example of the physical property information retrieval system according to the embodiment.

FIG. 3 is an explanatory diagram illustrating a protrusion degree of a peak and a width of the peak.

FIG. 4 is an explanatory diagram illustrating a notation method in a knowledge graph format according to the embodiment.

FIG. 5A is a diagram illustrating an example of a physical property case example information input screen 500A.

FIG. 5B is a diagram illustrating an example of a physical property case example information input screen 500B.

FIG. 6 is a diagram illustrating an example of a physical property case example information input screen 600 obtained by expanding a document frame 504 from the physical property case example information input screen 500B in FIG. 5B and reducing frames other than the document frame.

FIG. 7A is a diagram illustrating an example of an expanded substance specifying information frame 501 in the physical property case example information input screen 500B in FIG. 5B.

FIG. 7B is a diagram illustrating an example of the expanded substance specifying information frame 501 in the physical property case example information input screen 500B in FIG. 5B.

FIG. 8 is a diagram illustrating an example of an expanded measurement information frame 502 in the physical property case example information input screen 500B in FIG. 5B.

FIG. 9 is a diagram illustrating an example of an expanded analysis information frame 503 in the physical property case example information input screen 500B in FIG. 5B.

FIG. 10 is an explanatory diagram illustrating screen transition of retrieval condition setting and retrieval result display.

FIG. 11 illustrates an example of a substance information retrieval condition input screen 1010.

FIG. 12 illustrates an example of a retrieval result list screen 1020 displaying a list of retrieval results.

FIG. 13A illustrates an example of the retrieval result list screen 1020 displaying a list of retrieval results.

FIG. 13B illustrates an example of the retrieval result list screen 1020 displaying a list of retrieval results.

FIG. 14 illustrates an example of a measurement record screen 1030 showing measurement curves, measured physical property values, and measurement data characteristic information.

FIG. 15 illustrates an example of an analysis case example display screen 1041.

FIG. 16 illustrates an example of a measurement information display screen 1042.

FIG. 17 illustrates an example of a calculation condition display screen 1043.

### DESCRIPTION OF EMBODIMENTS

Hereinafter, embodiments of the invention will be described with reference to the drawings. However, the invention is not to be construed as being limited to the contents described in the following embodiments. It will be easily understood by those skilled in the art that the specific configuration can be changed without departing from the spirit or scope of the invention.

In the configurations of the invention described below, the same or similar configurations or functions are denoted by the same reference signs, and a redundant description will be omitted.

Notations “first”, “second”, “third”, and the like in the present specification and the like are provided to identify components, and do not necessarily limit the number or the order.

In the present specification and the like, an expression “XX table” may be used as an example of various types of information, and the various types of information may be expressed by a data structure such as “XX list” or “XX queue”. The “XX table” may be “XX information”. In describing identification information, when expressions such as “identification information”, “identifier”, “name”, “ID”, and “number” are used, the expressions can be replaced with one another.

### EMBODIMENT

### System Configuration

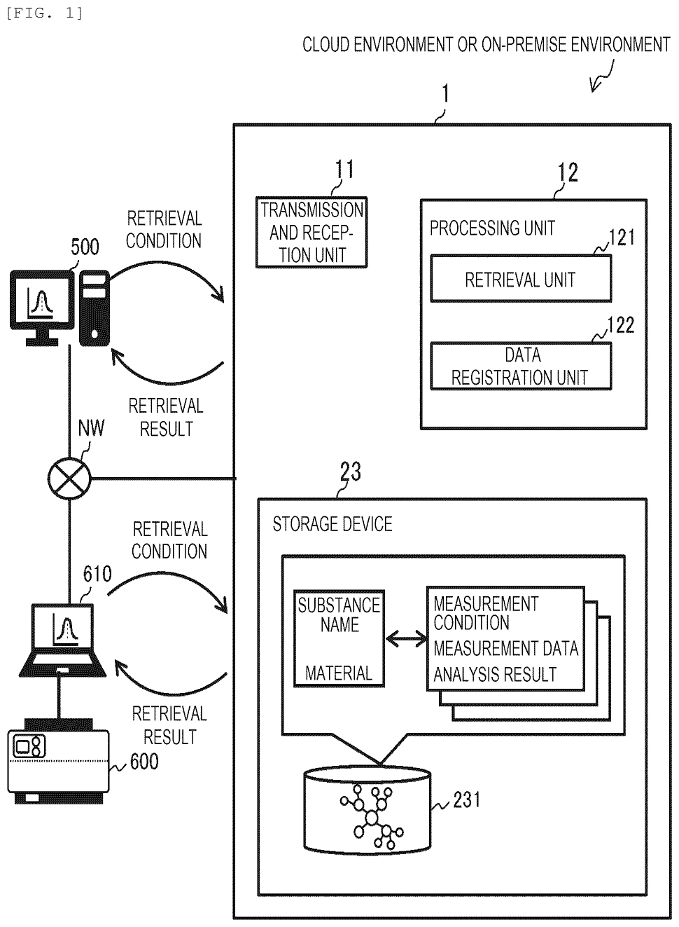

FIG. 1 is a diagram illustrating an example of a functional block diagram of a physical property information retrieval system 1 according to an embodiment. As illustrated in FIG. 1, the physical property information retrieval system 1 is connected to a user terminal 500 and a measurement control device 610 via a network NW. The physical property information retrieval system 1 is constructed in a server in a cloud environment. The physical property information retrieval system 1 may be constructed in a server in an on-premise environment.

The user terminal 500 and the measurement control device 610 are devices used by a user who inquires for information on a substance. The user terminal 500 and the measurement control device 610 can transmit and receive information to and from the physical property information retrieval system 1 via the network NW.

The user terminal 500 is a PC or the like used by an individual. The measurement control device 610 is a device that controls a measurement device 600. The measurement control device 610 causes the measurement device 600 to perform measurement based on measurement conditions and generates contiguous measurement data such as a spectrum. Further, the contiguous measurement data measured using the measurement device 600 is stored. The measurement device 600 is, for example, a measurement device using Chromatography, capillary electrophoresis, photoelectron spectroscopy, infrared absorption spectroscopy, nuclear magnetic resonance spectroscopy, fluorescence spectroscopy, X-ray fluorescent spectroscopy, visible/infrared absorption spectroscopy, Raman spectroscopy, atomic absorption spectroscopy, flame emission spectroscopy, emission spectroscopy, X-ray absorption spectroscopy, X-ray diffraction method, electron spin resonance spectroscopy, or mass spectrometry.

The network NW may be a wired network or a wireless network. The network NW may be a global network such as the Internet or a local area network (LAN).

The physical property information retrieval system 1 includes a storage device 23, a transmission and reception unit 11, and a processing unit 12. The storage device 23 stores a substance information database 231. The substance information database 231 stores information on a substance. The transmission and reception unit 11 transmits and receives data to and from the user terminal 500 and the measurement device 600.

The processing unit 12 includes a retrieval unit 121 and a data registration unit 122.

The retrieval unit 121 acquires information satisfying a retrieval condition from the substance information database 231 and outputs the information to the transmission and reception unit 11.

The data registration unit 122 allows the user of the user terminal 500 to input, using a knowledge graph, data to be stored in the substance information database 231, and stores the data input using the knowledge graph in the substance information database 231.

When the retrieval condition is transmitted from the user terminal 500 or the measurement control device 610 to the physical property information retrieval system 1, the transmission and reception unit 11 acquires the retrieval condition and outputs the acquired retrieval condition to the retrieval unit 121. The retrieval unit 121 acquires, from the substance information database 231, information satisfying the retrieval condition acquired from the transmission and reception unit 11 and outputs the information to the transmission and reception unit 11. Then, the transmission and reception unit 11 returns the information satisfying the retrieval condition acquired from the retrieval unit 121 to the user terminal 500 or the measurement control device 610 from which the retrieval condition is transmitted.

When the user terminal 500 or the measurement control device 610 transmits information indicating that information is to be stored in the substance information database 231 to the physical property information retrieval system 1, the data registration unit 122 returns a template of physical property case example information in the format of a knowledge graph. When the information to be stored in the substance information database 231 is input, the user terminal 500 or the measurement control device 610 transmits the information to be stored in the substance information database 231 to the physical property information retrieval system 1. The physical property information retrieval system 1 stores, in the substance information database 231, the received information to be stored in the substance information database 231.

### Hardware Configuration of Physical Property Information Retrieval System 1

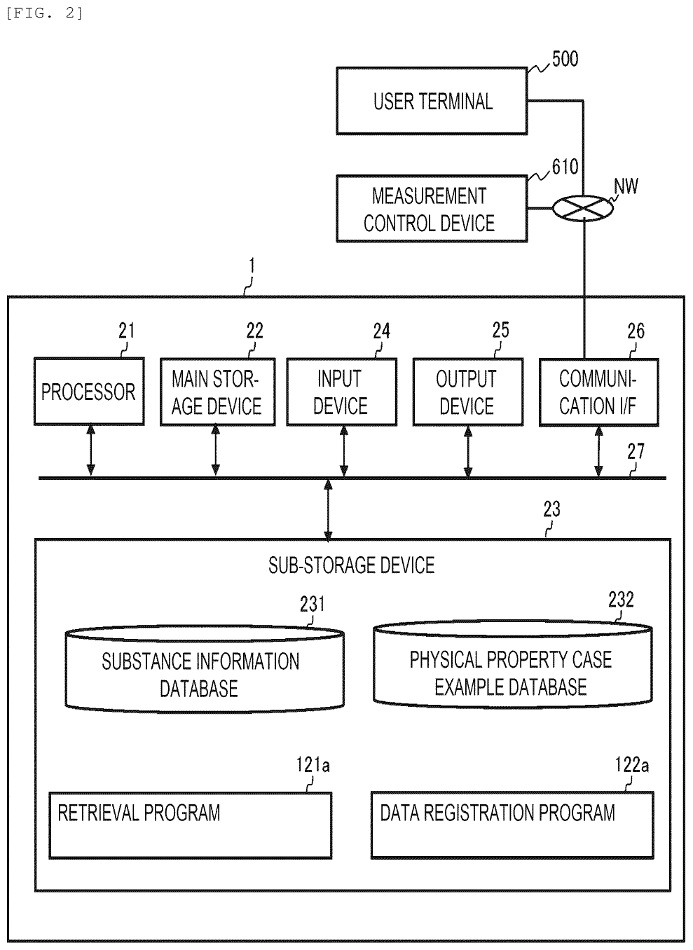

FIG. 2 is a block diagram illustrating a hardware configuration example of the physical property information retrieval system 1. As illustrated in FIG. 2, the physical property information retrieval system 1 includes a processor 21, a main storage device 22, a sub-storage device 23, an input device 24, an output device 25, a network I/F 26, and a bus 27 that connects these components.

The physical property information retrieval system 1 can be implemented by a general information processing device such as a PC or a server computer. The user terminal 500 and the measurement control device 610 can also be implemented using hardware resources similar to those of the physical property information retrieval system 1.

The processor 21 reads data and programs stored in the sub-storage device 23 to the main storage device 22, and executes processing determined by the programs.

The main storage device 22 includes a volatile storage element such as a RAM or the like, and stores programs executed by the processor 21 and data.

The sub-storage device 23 is a device that includes a nonvolatile storage element such as a hard disk drive (HDD) or a solid state drive (SSD) and stores programs, data, and the like. The sub-storage device 23 stores the substance information database 231 and a physical property case example information database 232, which will be described in detail later. The substance information database 231 stores data for substances. The physical property case example information database 232 stores a template of a record of the substance information database 231 that is used when the data registration unit 122 registers data (record) in the substance information database 231.

A retrieval program 121a and a data registration program 122a are installed in the sub-storage device 23. The retrieval unit 121 and the data registration unit 122 described above with reference to FIG. 1 are implemented by the processor 21 reading the retrieval program 121a and the data registration program 122a stored in the sub-storage device 23 to the main storage device 22 and executing the retrieval program 121a and the data registration program 122a. The processor 21 is the processing unit 12.

The input device 24 is a device such as a keyboard or a mouse that receives an operation of a user, and acquires information input by the operation of the user. The output device 25 is a device such as a display that outputs information, and presents information to the user, for example, by display on a screen.

The network I/F 26 is an interface for transmitting and receiving data to and from a device such as the user terminal 500 via the network NW. That is, the network I/F 26 is a transmission and reception device capable of transmitting and receiving information to and from the user terminal 500 via the network NW. The physical property information retrieval system 1 can transmit and receive data to and from a device by using the network I/F 26 such as the user terminal 500 connected to the network NW.

### Configuration of Substance Information Database 231

The substance information database 231 stores physical property case example information in which substance specifying information for specifying a substance is associated with at least one piece of measurement record information that is information of a set of contiguous measurement data for a substance, information on a measurement condition of the measurement data, a physical property value (referred to as a “measured physical property value”) calculated based on the measurement data, and measurement data characteristic information indicating a characteristic of the measurement data. The physical property case example information includes the substance specifying information, and may also include information other than the substance specifying information, such as information on a substance manufacturing method and information on a document in which the measurement data is described.

The physical property case example information stored in the substance information database 231 is data for one substance.

The physical property specifying information is information for specifying a substance that can be an object to be measured, such as a pure substance, an inorganic compound, an organic compound, or a resin. The substance specifying information is, for example, a substance name. The substance specifying information may be a list of IUPAC names and common names of substances. When the substance is a mixture of a resin or the like, the physical property specifying information may be a composition of a resin material.

The contiguous measurement data for a substance may be, for example, measurement data obtained by chromatography such as HPLC or gas chromatography. The measurement data may be measurement data obtained by electrophoresis such as capillary electrophoresis or two-dimensional electrophoresis. The measurement data may be measurement data obtained by a spectroscopic measurement method such as photoelectron spectroscopy, infrared absorption spectroscopy, nuclear magnetic resonance spectroscopy, fluorescence spectroscopy, X-ray fluorescent spectroscopy, visible/infrared absorption spectroscopy, Raman spectroscopy, atomic absorption spectroscopy, flame emission spectroscopy, emission spectroscopy, X-ray absorption spectroscopy, X-ray diffraction method, electron spin resonance spectroscopy, one-dimensional NMR, or two-dimensional NMR. The measurement data may be measurement data obtained by mass spectrometry or the like. The measurement data may be measurement data obtained by thermal analysis such as DSC. The measurement data may be AFM image data or SEM image data.

The information on a measurement condition of the measurement data includes information on parameters set in the measurement, and also includes information on the measurement method.

The measured physical property value is, for example, a peak position or a peak intensity of the contiguous measurement data for a substance.

The measurement data characteristic information includes at least one value indicating a shape feature of a measurement curve, which does not depend on the interpretation of the measurement curve created by plotting the measurement data and can be calculated based on the measurement curve by numerical analysis. The value included in the measurement data characteristic information is preferably a value that does not indicate a physical property of the substance to be measured in the measurement data.

The measurement data characteristic information of the embodiment is, for example, a shape feature vector that is a set (vector format) of information (a peak position (a value of the horizontal axis) specifying a peak, a protrusion degree of the peak, and a width of the peak), regarding a measurement curve created by plotting measurement data and a differential measurement curve obtained by differentiating the measurement curve. The information specifying a peak can be calculated based on the measurement data by a known algorithm. The measurement curve may be smoothed, and the shape feature vector may be calculated based on information specifying a peak of the smoothed measurement curve and information specifying a peak of a differential measurement curve of the smoothed measurement curve.

The information specifying a peak includes data corresponding to a peak having an extreme value (a local maximum value and a local minimum value). That is, in a peak detection result, a value on a horizontal axis (for example, a temperature in the case of a differential scanning calorimeter (DSC)), the protrusion degree of a peak, and the width of the peak are calculated for two types of peaks, that is, a peak having a local maximum value protruding upward and a peak having a local minimum value recessed downward.

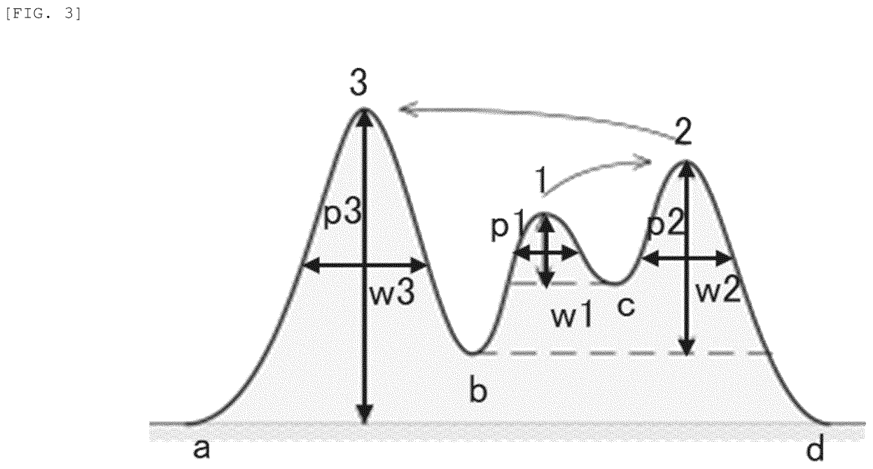

FIG. 3 is an explanatory diagram illustrating the protrusion degree of a peak and the width of the peak. In a case where an apex (extreme value) moves on the measurement curve from an apex (extreme value) of a peak to an apex (extreme value) of a peak higher (higher intensity) than the apex (extreme value) of the peak with respect to an apex (extreme value) of a peak, the protrusion degree is the height measuring from the apex (extreme value) of the peak to a lowest position, in a movement path where the height (intensity) from the apex (extreme value) of the peak is minimum among movement paths. When the height (intensity) of the apex (extreme value) of the peak is the largest (or the smallest) in the measurement curve, the protrusion degree of the peak is defined as the height (intensity) of the apex (extreme value) of the peak with respect to a base line.

In FIG. 3, at a peak 1, the protrusion degree of the peak is p1, and the width of the peak is w1. Similarly, at a peak 2, the protrusion degree of the peak is p2, and the width of the peak is w2. At a peak 3, the protrusion degree of the peak is p3, and the width of the peak is w3.

Since the measurement curve intersects the peak 2 at a local minimum value c (it is necessary to decrease to the local minimum value c), the protrusion degree of the peak 1 is p1. The protrusion degree of the peak 2 is p2 since the measurement curve intersects the peak 3 (a peak higher than the peak 2) at a local minimum value b. The local maximum value of the peak 3 is the maximum value, the protrusion degree thereof is p3. The width of the peak is defined as a width of a half protrusion degree.

### Processing

Next, processing of the physical property information retrieval system 1 will be described. As described above, the retrieval unit 121 retrieves a condition satisfying a retrieval condition from the substance information database 231. The data registration unit 122 receives, using a graph in the format of a knowledge graph, an input of information on a substance to be registered in the substance information database 231, and stores the input information on the substance in the substance information database 231.

In the following, first, storage of the information on the substance, which is performed by the data registration unit 122, will be described, and then an example of retrieval by the retrieval unit 121 will be described.

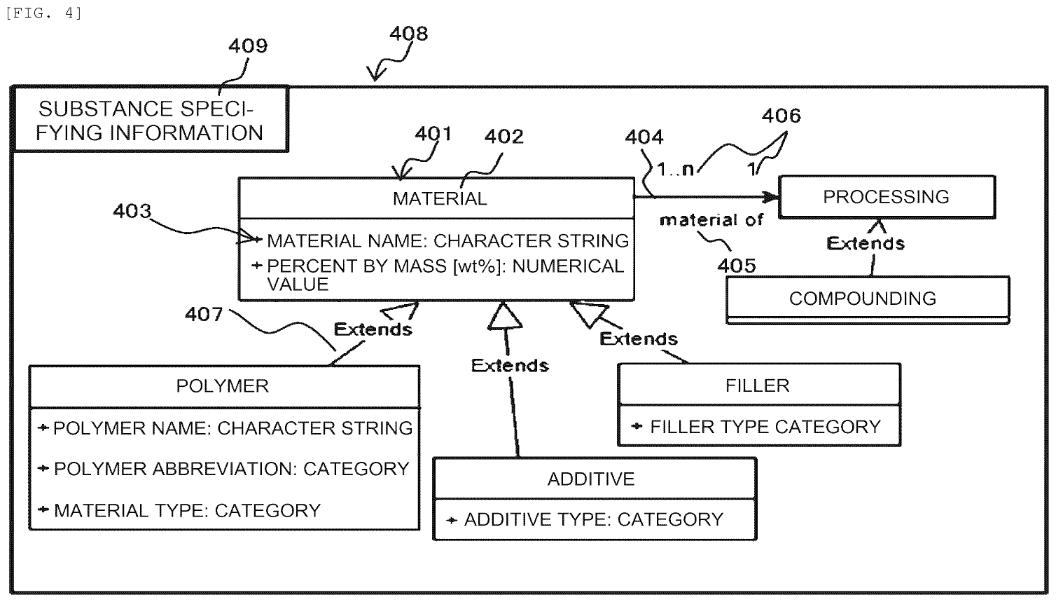

### 1. Storage of Information on Substance to Substance Information Database 231, FIGS. 4 to 9

The user operates the user terminal 500 or the measurement control device 610 to cause the user terminal 500 or the measurement control device 610 to access the physical property information retrieval system 1. When the physical property information retrieval system 1 is accessed from the user terminal 500, the data registration unit 122 transmits condition input screen information to the user terminal 500.

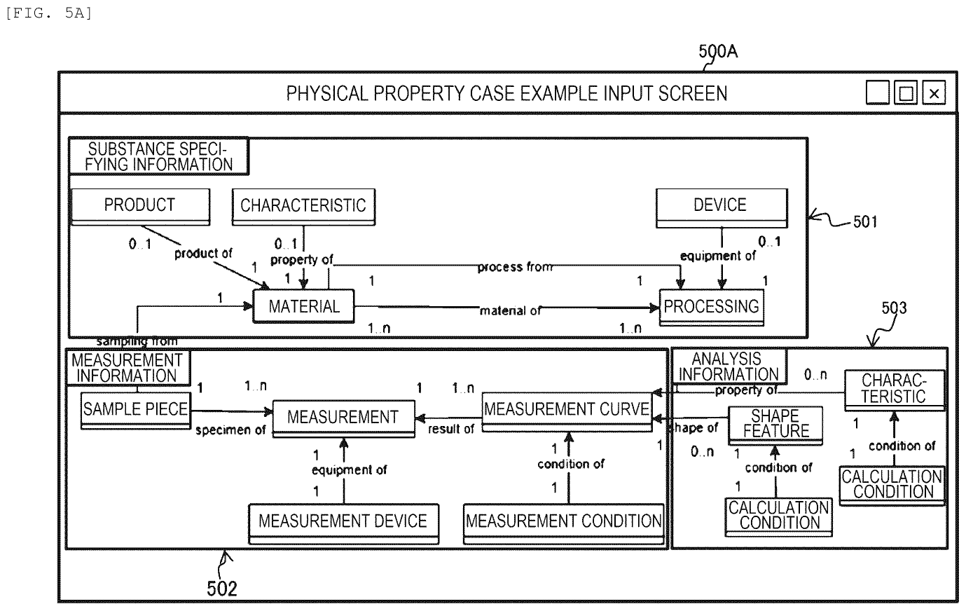

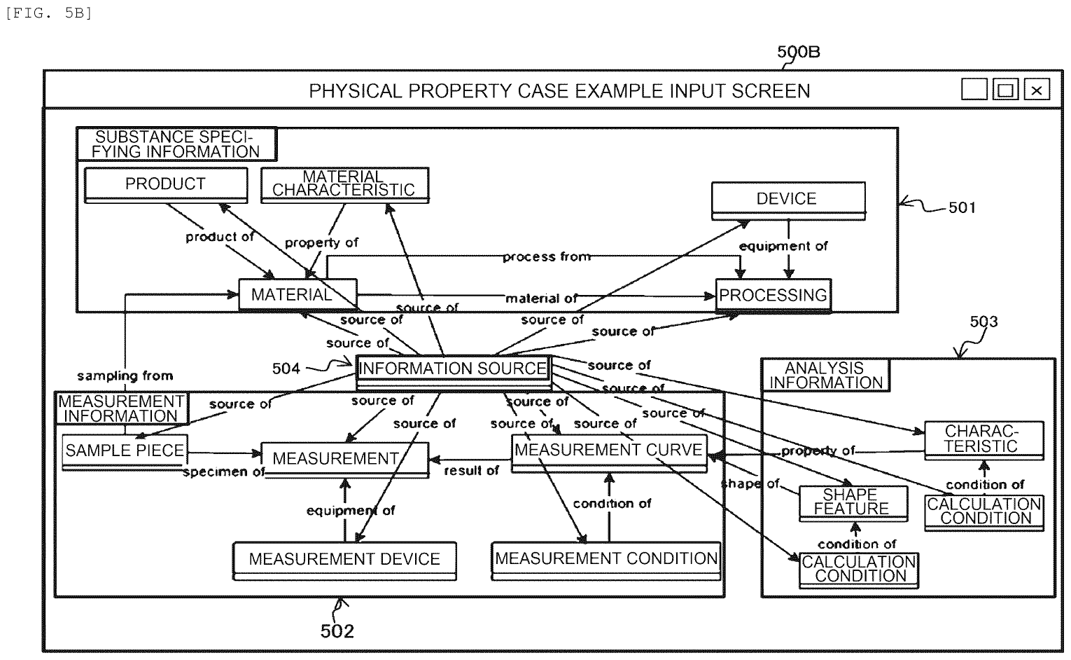

The data registration unit 122 acquires a template of physical property case example information stored in the substance information database 231 from the physical property case example information database 232, and converts the acquired template of physical property case example information into a knowledge graph format. Then, the data registration unit 122 generates physical property case example information input screen information. The physical property case example information input screen information includes information on a configuration of a physical property case example information input screen including information on the template of the physical property case example information in a knowledge graph format, and information indicating that the physical property case example information input screen is to be displayed on the user terminal 500 or the measurement control device 610. The physical property case example information input screen (see FIGS. 5A and 5B) is a screen that displays the template of the physical property case example information in the knowledge graph format and receives input of the physical property case example information. Further, the data registration unit 122 causes the transmission and reception unit 11 to transmit the generated physical property case example information input screen information to the user terminal 500 or the measurement control device 610. Hereinafter, a notation method in the knowledge graph format of the embodiment will be described. Next, an example of the physical property case example information input screen will be described.

As described above, the data registration unit 122 generates physical property case example information knowledge graph information in which the template of the physical property case example information is converted into the knowledge graph format, outputs the physical property case example information knowledge graph information to the user terminal 500 and the measurement control device 610, and when physical property case example information created based on the physical property case example information knowledge graph information is acquired, stores the acquired physical property case example information created based on the physical property case example information knowledge graph information in the substance information database 231.

### Notation Method in Knowledge Graph Format

FIG. 4 is an explanatory diagram illustrating the notation method in the knowledge graph format of the embodiment. The notation method of the knowledge graph format of the embodiment is a knowledge graph format incorporating a notation method used for a class diagram of a unified modeling language (UML). As illustrated in FIG. 4, a class 401, a class name 402, an instance, an attribute and attribute value 403, a relation 404, an association name 405, a multiplicity 406, a generalization relation 407, a frame 408, and a frame name 409 are used as a notation method of the UML class diagram incorporated in the knowledge graph.

In the knowledge graph of the embodiment, a “class” and an “instance” corresponding to nodes are used. The class functions as a “template”. Specific information input using a class is referred to as an “instance”. FIG. 4 illustrates a knowledge graph in which a node represents a “class”.

As illustrated in FIG. 4, the class represents a concept such as “material” or “product”. The class is represented by a rectangular box. A rectangular box representing the class 401 is divided by a line into a section of a class name in which the class name 402 is described and a section of an attribute list. The attribute and attribute value 403 is a set of an attribute and an attribute value. The attribute is a property of the class. The attribute value is a value corresponding to the attribute. As illustrated in FIG. 4, for example, the class 401 is a class whose class name 402 is “material”. The attribute of the attribute and attribute value 403 included in the attribute list of the class 401 is “material name”, and the attribute value thereof is “character string (specific material name)”.

In the knowledge graph of the embodiment, an arrow 404 representing the relation (edge) 404 is drawn between a plurality of classes that are significantly related to each other. In the knowledge graph of the embodiment, the arrow 404 connecting a plurality of classes indicates that there is a significant relationship between the plurality of classes. The association name 405 indicates what meaning a plurality of classes connected by arrows have. Normally, the association name 405 is a verb indicating how a plurality of classes related to each other behave. The multiplicity 406 indicates, in the relationship between a plurality of classes indicated by the relation (arrow) 404, the limitation on the number of classes (the relationship is indicated by the arrow) on one side of the arrow 404 with respect to the other side of the arrow.

The generalization relation (inheritance) 407 indicates that a general class (parent class) and a special class (child class) with respect to the general class (parent class) have a generalization-specialization (general-special) relationship. The generalization relation (inheritance) 407 is indicated by an arrow 407 having a triangle attached to the parent class side.

The frame 408 indicates a group of nodes in which a plurality of nodes that can be integrated by the concept of lumping together are integrated. The frame 408 is indicated by a rectangle that surrounds a plurality of nodes that can be integrated by the concept of lumping together. The frame name 409 is drawn at an upper left portion of the rectangle indicating the frame.

The attribute and attribute value 403, the relation 404, the association name 405, the multiplicity 406, the generalization relation 407, and the frame 408 described above are also used in the same manner in the knowledge graph in which a node represents an “instance (specific information of the class)”.

### Example of Physical Property Case Example Information Input Screen

FIG. 5A is a diagram illustrating an example of a physical property case example information input screen 500A. FIG. 5A is an example of the physical property case example information input screen 500A for creating the physical property case example information that stores a novel substance and measurement data thereof. The physical property case example information input screen 500A in FIG. 5A includes a substance specifying information frame 501, a measurement information frame 502, and an analysis information frame 503. These frames are reduced and expanded when clicked. The substance specifying information frame 501 includes a “material class” for inputting substance specifying information.

The measurement information frame 502 and the analysis information frame 503 are at least one piece of measurement record information that is information of a set of contiguous measurement data for a substance, information on a measurement condition of the measurement data, a measured physical property value calculated based on the measurement data, and measurement data characteristic information indicating a characteristic of the measurement data.

The measurement information frame 502 includes a class for inputting information on a measurement condition of the measurement data. The measurement information frame 502 includes a “sample piece class” for inputting information on a sample, a “measurement class” for inputting information on a measurement environment, a “measurement device class” for inputting information on a measurement device, a “measurement curve class” for inputting measurement data, and a “measurement condition class” for inputting information on a measurement condition.

The analysis information frame 503 includes a class for inputting a measured physical property value calculated based on measurement data and a class for inputting measurement data characteristic information indicating a characteristic of the measurement data. The analysis information frame 503 includes a “characteristic class” for inputting a measured physical property value and a “shape feature class” for inputting measurement data characteristic information.

FIG. 5B is a diagram illustrating an example of a physical property case example information input screen 500B. FIG. 5B is an example of the physical property case example information input screen 500B for creating the physical property case example information that stores a substance and measurement data thereof described in a document. The physical property case example information input screen 500B in FIG. 5B includes an “information source frame 504” which is a document frame, in addition to the physical property case example information input screen 500A in FIG. 5A. The frames 501 to 504 shown in FIG. 5B are reduced and expanded when clicked, similarly to the frames 501 to 503 shown in FIG. 5A. Similarly to the physical property case example information input screen 500A in FIG. 5A, when the right click is performed on the physical property case example information input screen 500B in FIG. 5B, a menu for displaying “addition and deletion of the class, the class name, the instance, the attribute and attribute value, the relation, the association name, the multiplicity, the generalization relation, the frame, and the frame name” is displayed, and a selected operation is executed.

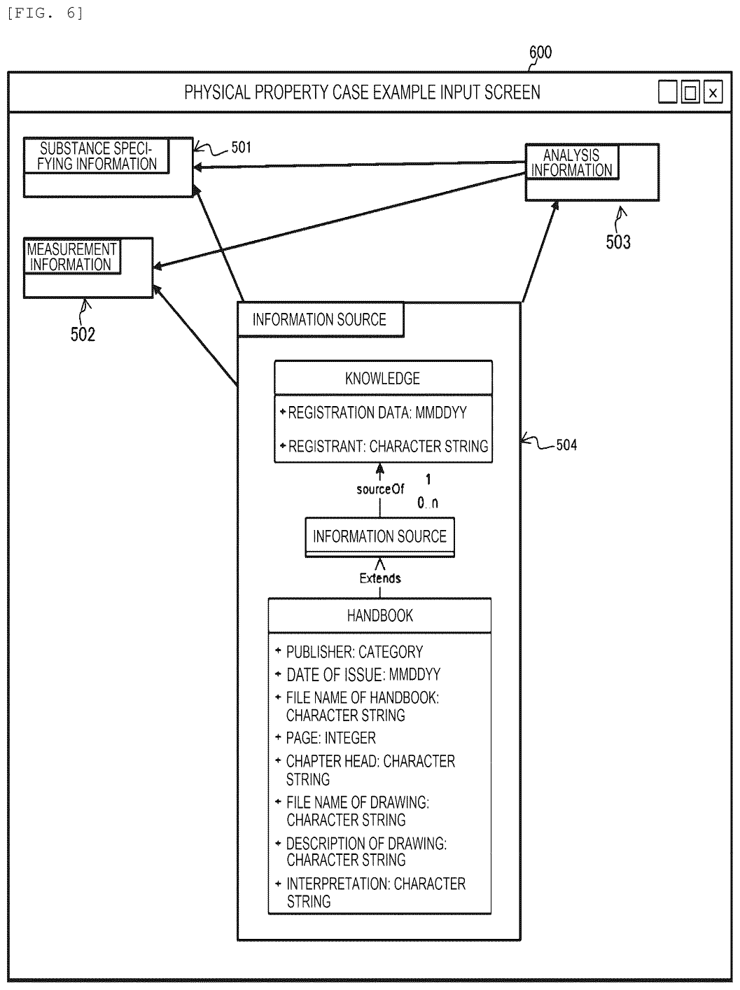

FIG. 6 is a diagram illustrating an example of a physical property case example information input screen 600 obtained by expanding the document frame 504 from the physical property case example information input screen 500B in FIG. 5B and reducing frames other than the document frame.

In the document frame 504, a name “handbook” of a class of document information is input, and an instance whose name is “handbook” is created. The instance of “handbook” has attributes such as a name of the handbook in which physical property case example information is described, a title of the physical property case example information, a drawing, and an outline. All the unedited classes included in the instance of the “handbook” are linked to an “information source class”.

As illustrated in FIG. 6, on the physical property case example information input screen, since the physical property case example information is presented in the knowledge graph format, constituent elements of the physical property case example information are easily grasped. In addition, on the physical property case example information input screen, since the physical property case example information is presented in the knowledge graph format, it is possible to display, in a relatively large size, a portion (instance or frame) for inputting information by expanding the portion (instance or frame) for inputting information and reducing a portion (instance or frame) not inputting information. This makes it easy to input information to the physical property case example information. Consequently, it is easy to register the physical property case example information in the substance information database 231.

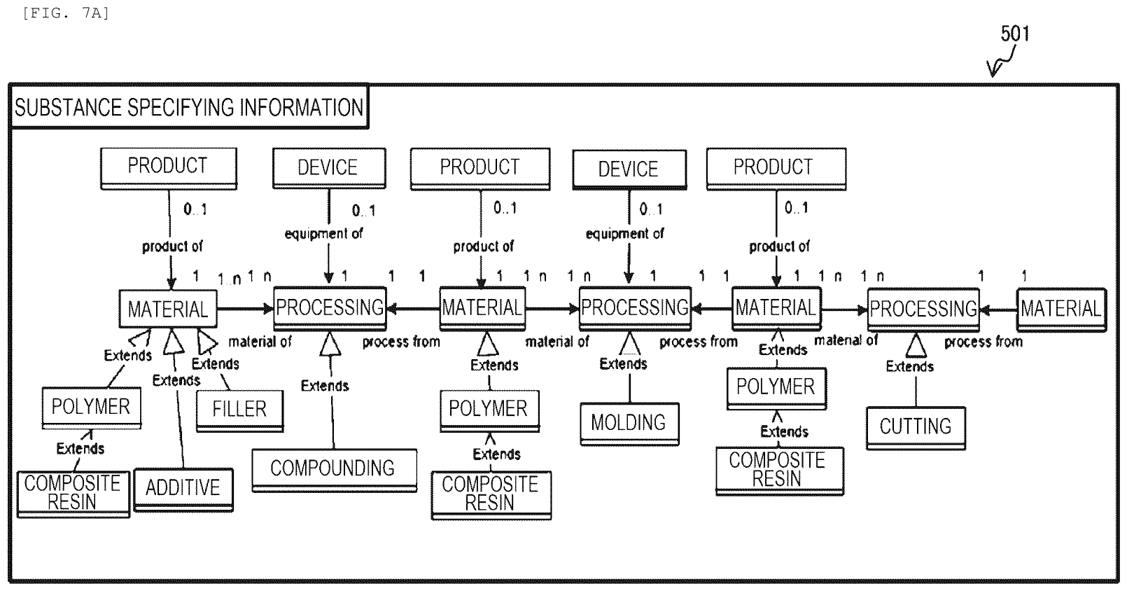

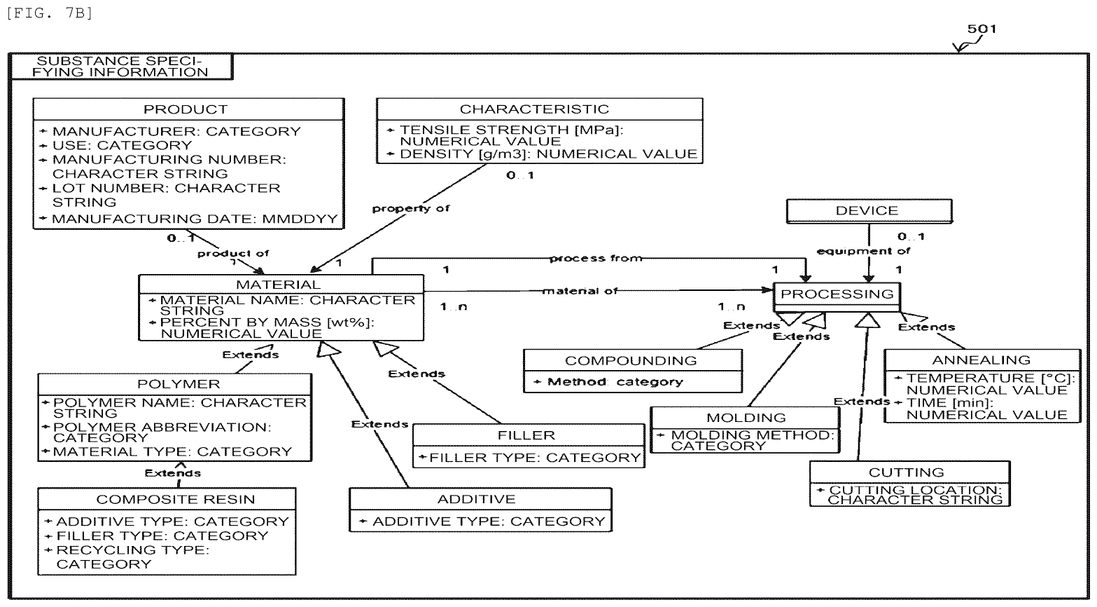

FIG. 7A is a diagram illustrating an example of an expanded substance specifying information frame 501 in the physical property case example information input screen 500B in FIG. 5B. In the substance specifying information frame 501 in FIG. 7A, an example of repetition of processing for a material is described, and description of an attribute of each instance and a specific name is omitted.

FIG. 7B is a diagram illustrating an example of an expanded substance specifying information frame 501 in the physical property case example information input screen 500B in FIG. 5B. In the substance specifying information frame 501 in FIG. 7B, an attribute value of each instance is input. However, in FIG. 7B, description of the specific values of the attribute values is omitted.

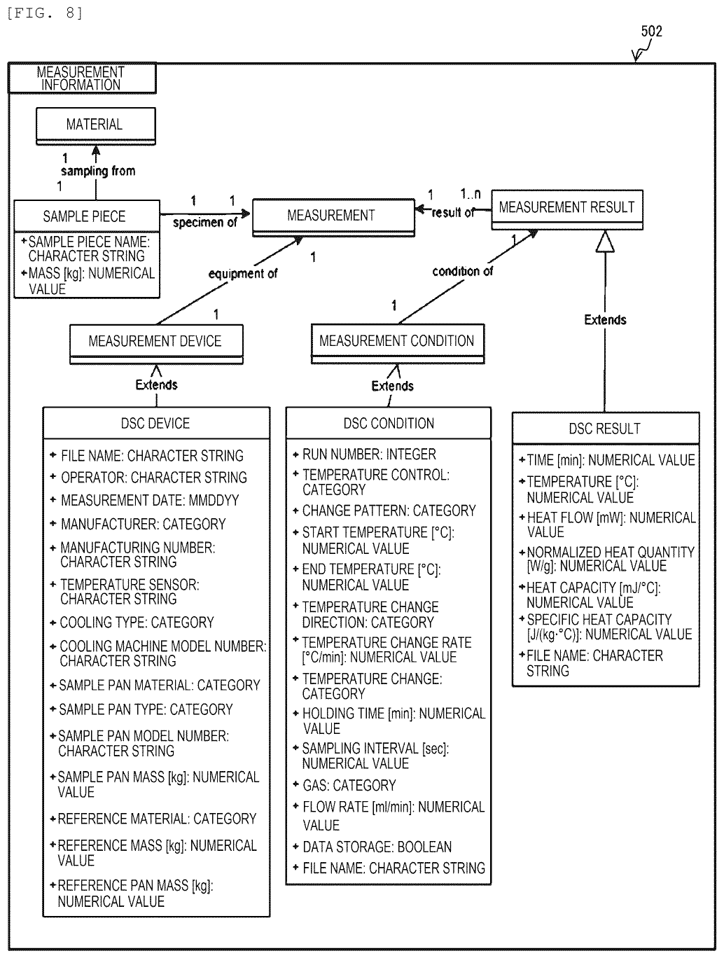

FIG. 8 is a diagram illustrating an example of an expanded measurement information frame 502 in the physical property case example information input screen 500B in FIG. 5B. The measurement information frame 502 in FIG. 8 shows the measurement information frame 502 in a case where DSC is used for the measurement as an example.

The measurement information frame 502 includes a class for inputting information on a measurement condition of the measurement data. The measurement information frame 502 includes a “sample piece class” for inputting information on a sample, a “measurement class” for inputting information on a measurement environment, a “measurement device class” for inputting information on a measurement device, a “measurement curve class” for inputting measurement data, and a “measurement condition class” for inputting information on a measurement condition.

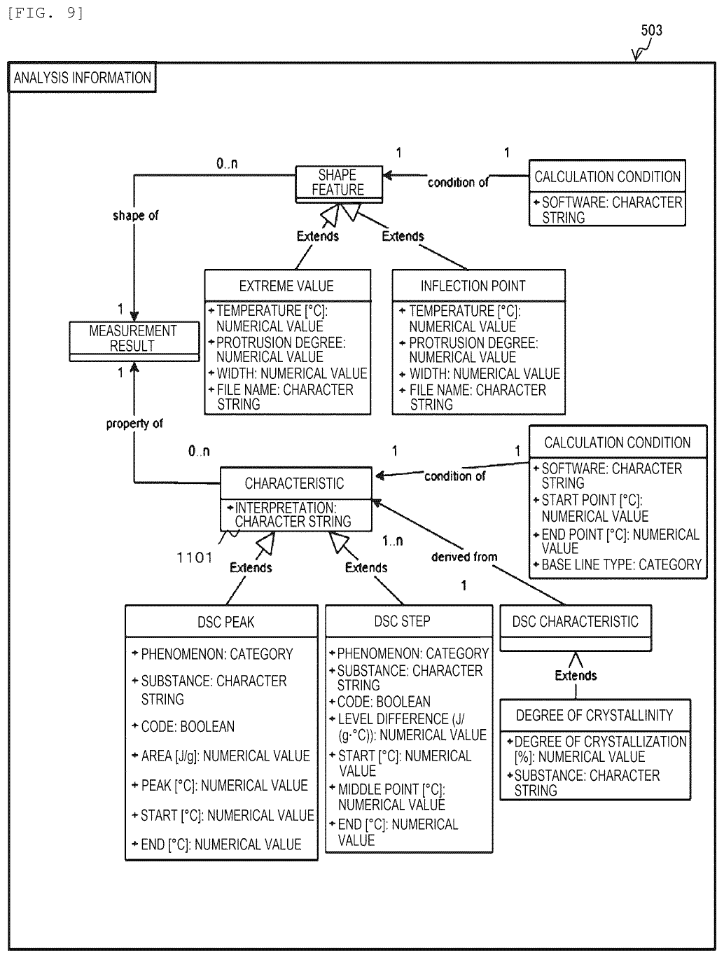

FIG. 9 is a diagram illustrating an example of an expanded analysis information frame 503 in the physical property case example information input screen 500B in FIG. 5B. The analysis information frame 503 in FIG. 0 shows the analysis information frame 503 in a case where DSC is used for the measurement as an example.

The analysis information frame 503 includes a class for inputting a measured physical property value calculated based on measurement data and a class for inputting measurement data characteristic information indicating a characteristic of the measurement data. The analysis information frame 503 includes a “characteristic class” for inputting a measured physical property value and a “shape feature class” for inputting measurement data characteristic information.

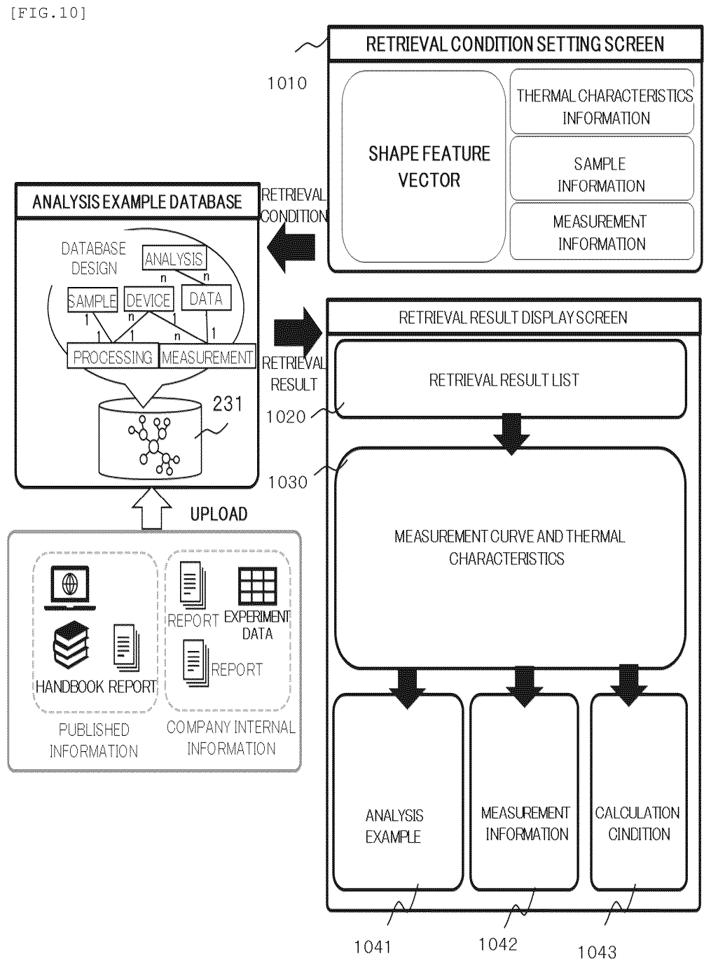

### 2. Example of Retrieval Using Substance Information Database 231, FIGS. 10 to 17

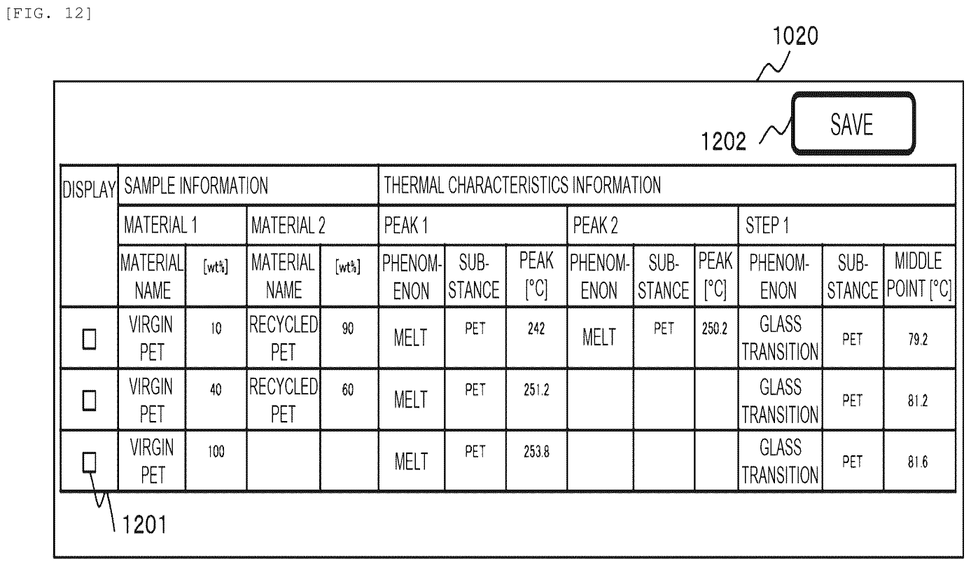

FIG. 10 is an explanatory diagram illustrating a screen transition of retrieval condition setting and retrieval result display. In the physical property information retrieval system 1, the retrieval condition setting and the retrieval result display are performed by a graphical user interface (GUI). As illustrated in FIG. 10, for example, a retrieval condition (substance information retrieval condition) including at least one of the following information is input to a substance information retrieval condition input screen 1010: the substance specifying information, the measurement data, information included in the information on the measurement condition of the measurement data, information included in the measurement data characteristic information, and information included in the physical property information, such as thermal property information, sample information, measurement information, and a shape feature vector. Information on the substance information retrieval condition input screen 1010 is transmitted from the physical property information retrieval system 1 to the user terminal 500 or the measurement control device 610. When the substance information retrieval condition input using the substance information retrieval condition input screen 1010 on the user terminal 500 or the measurement control device 610 is transmitted to the physical property information retrieval system 1 by the user terminal 500 or the measurement control device 610, the retrieval unit 121 retrieves the substance information database 231 to acquire substance case example information satisfying the substance information retrieval condition, and causes the transmission and reception unit 11 to output (transmit) the substance case example information satisfying the substance information retrieval condition acquired by an information retrieval unit to the user terminal 500 or the measurement device 600. Then, the user terminal 500 or the measurement device 600 displays the substance case example information as shown in FIGS. 12 to 17.

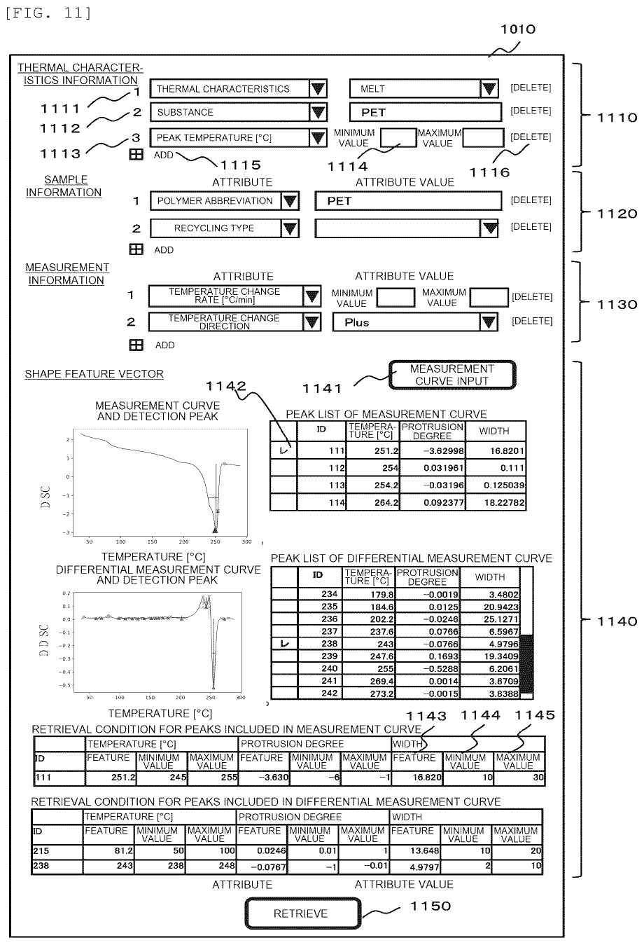

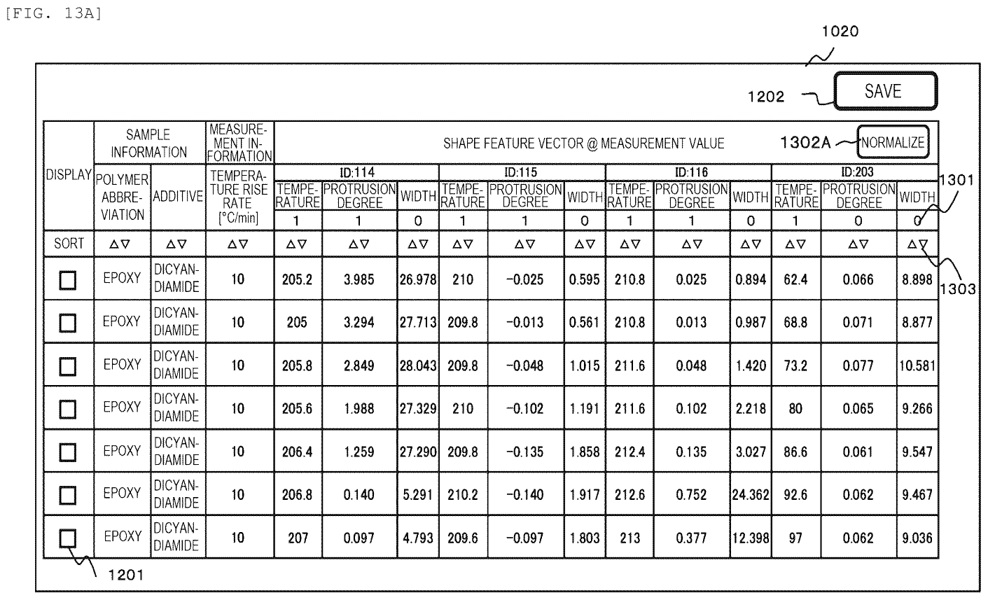

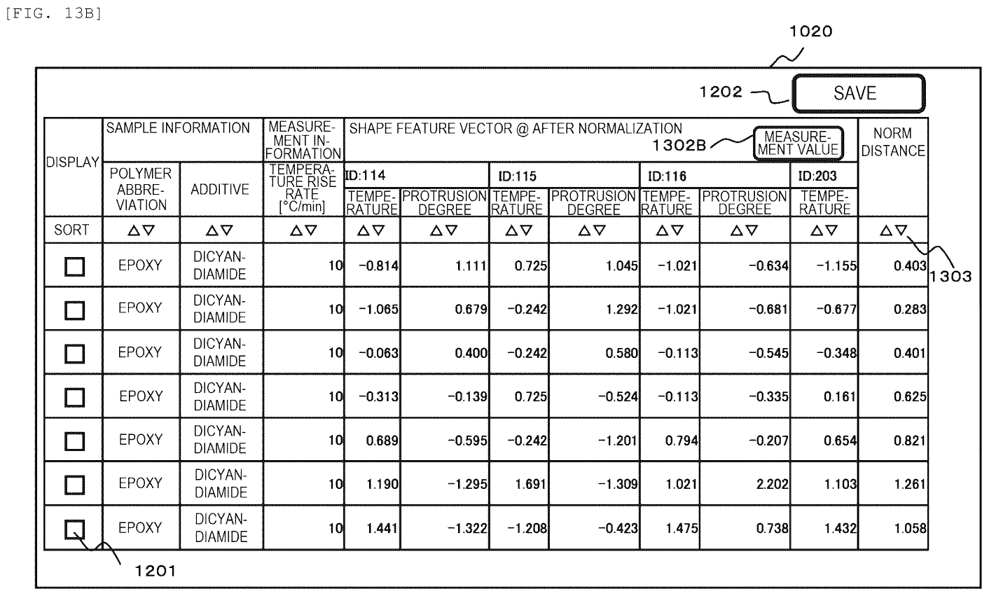

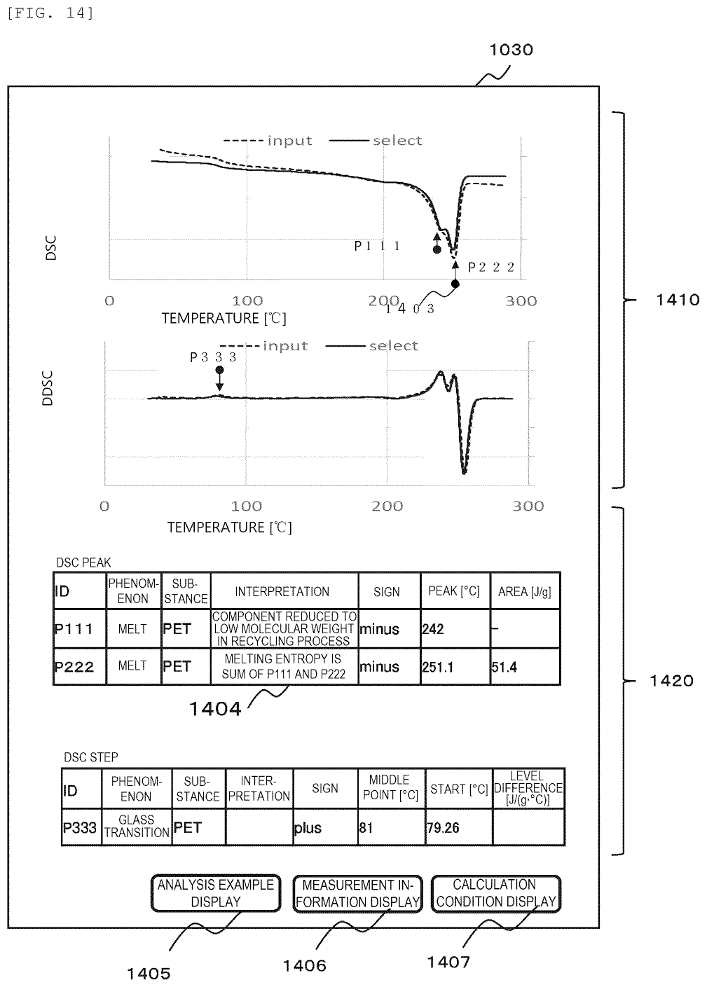

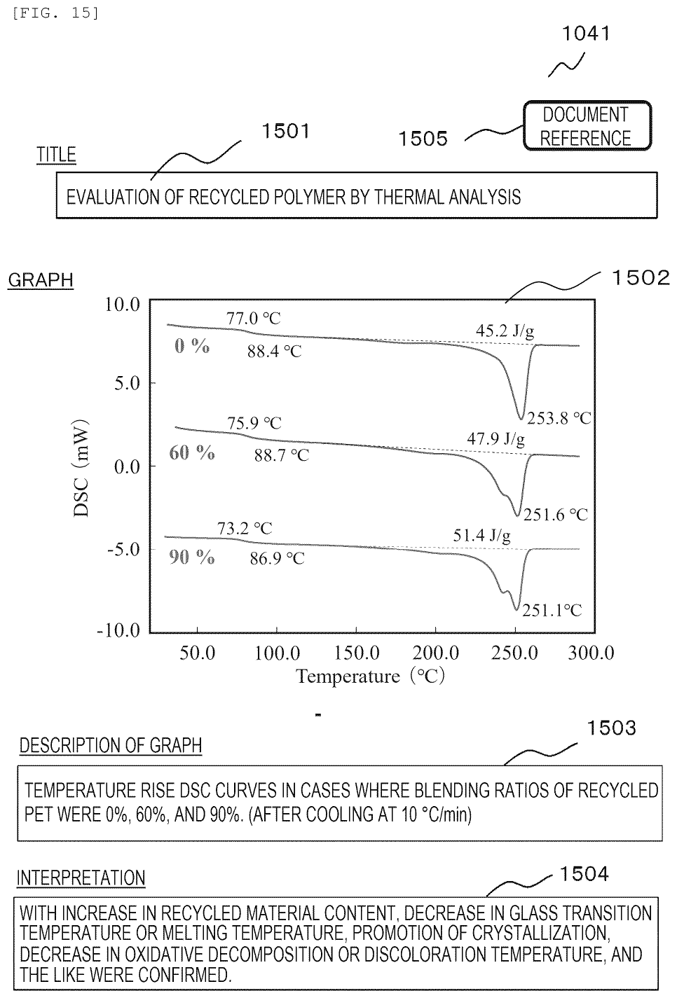

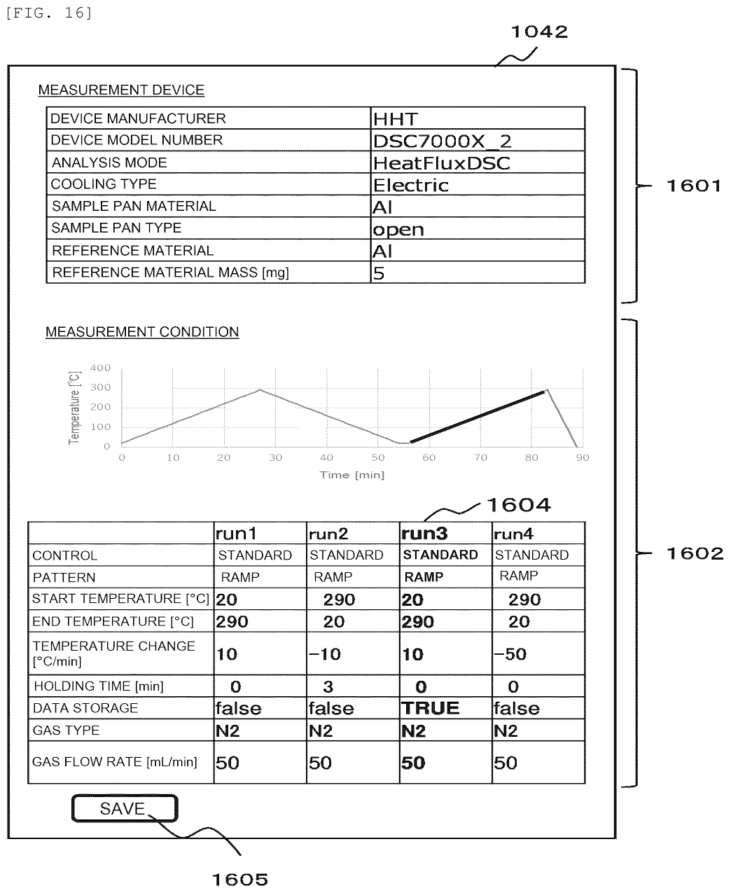

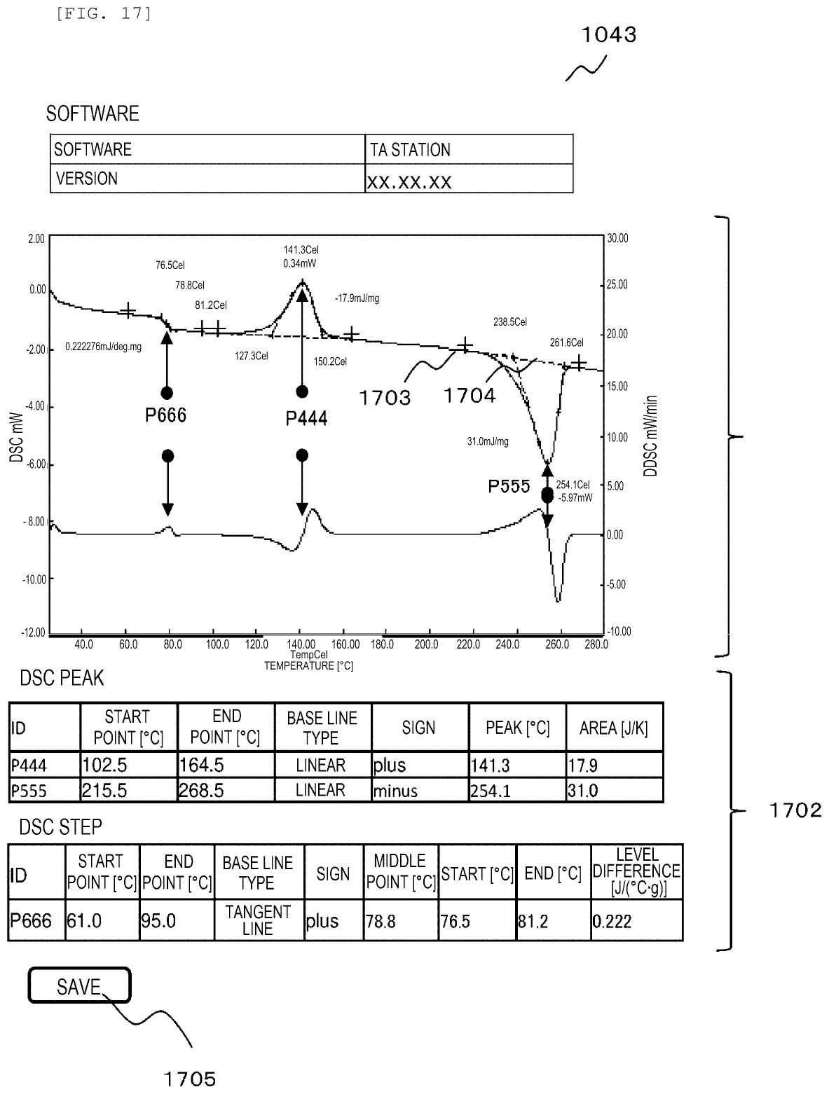

Details thereof will be described below. FIG. 11 illustrates an example of the substance information retrieval condition input screen 1010. FIGS. 12, 13A, and 13B illustrate examples of a retrieval result list screen 1020 that displays a list of retrieval results. FIG. 14 illustrates an example of a measurement record screen 1030 showing measurement curves, measured physical property values, and measurement data characteristic information. FIG. 15 illustrates an example of an analysis case example display screen 1041. FIG. 16 illustrates an example of a measurement information display screen 1042. FIG. 17 illustrates an example of a calculation condition display screen 1043. Hereinafter, each screen will be described in detail.

The substance information retrieval condition input screen 1010 illustrated in FIG. 11 includes a thermophysical property input area 1110 for receiving an input of thermophysical property information, a substance specifying information input area 1120 for inputting substance specifying information, a measurement condition input area 1130 for inputting information on measurement conditions, a measurement result input area 1140 for inputting measured physical property values and measurement data characteristic information, and a retrieval start button 1150 for transmitting the substance information retrieval condition input to the substance information retrieval condition input screen 1010 to the physical property information retrieval system 1 when pressed.

In the thermophysical property input area 1110, when an attribute of a property registered in the thermophysical property information is selected in a pull-down list, an input form corresponding to the type of an attribute value thereof is displayed. For example, when the attribute is a thermophysical property (1111), the type of the attribute value thereof is set to a category of selecting the attribute value from registration list, and the input form of the attribute value is set to select items such as melting, crystallization, and enthalpy relaxation in a pull-down list. When the attribute is a substance (1112), the type of the attribute value thereof is set to a character string, and the input form of the attribute value is set to input a character string used for key word retrieval. When the attribute is a peak temperature (1113), the type of the attribute value thereof is set to a numerical value, and the input form of the attribute value is set to input a retrieval range of the numerical value. When the attribute is specified in a pull-down list and the attribute value is blank (1114), the attribute is not used for a retrieval condition, but the attribute value thereof is displayed in the retrieval result list. When an add button 11115 provided in the input area is clicked, a pull-down list of attribute selection is added. When a delete button 1116 is clicked, the pull-down list of attribute selection and the input form of the attribute value are deleted. The same configuration applies to a sample information input area and a measurement information input area.

Next, the measurement result input area 1140 will be described in detail. When a measurement curve input button 1141 is clicked, another screen for selecting a measurement curve is displayed. When a measurement curve is selected on the screen, the selected measurement curve and a differential measurement curve thereof, and respective peak detection results are displayed. When a check 1142 is put in a left end column in a table of a peak list of the measurement curve, a peak is selected, and a feature vector (temperature, protrusion degree, width) is registered in a feature field 1143 of a detection condition of the peak included in the measurement curve. The user inputs numerical values in fields of a retrieval lower limit 1144 and an upper limit 1145 of the feature vector with reference to a value of the feature vector. For the differential measurement curve, the peak of interest is selected in the same procedure, and a retrieval range of the feature vector is input. When a retrieval start button 11150 at the bottom of the screen is clicked, the substance information retrieval condition input to the substance information retrieval condition input screen 1010 is transmitted to the physical property information retrieval system 1, and the AND retrieval of the substance information retrieval condition is executed.

The retrieval result list screen 1020 displaying a list of retrieval results shown in FIG. 12 shows a retrieval result list. The attributes input on the substance information retrieval condition input screen 1010 shown in FIG. 11 are assigned to items in columns of the result list. The attribute values of the retrieved measurement curves are displayed by rows. In a case where it is desired to confirm details of the retrieved measurement curve, when a display button 1201 provided at the left end of the list is clicked, the details of the measurement curve are displayed on another screen.

Default display items are provided for a sample and a thermophysical property. When the sample includes a plurality of materials, all the materials are displayed in a list, and when the measurement curve includes a plurality of thermal characteristics, all the thermal characteristics are displayed in a list. The user specifies a display item other than the default display items by inputting a retrieval condition. For example, when it is desired to display a peak temperature of the thermophysical property, the peak temperature is set in a pull-down list. In a case where it is desired to confirm details of the physical property information included in the displayed measurement curve, when the display button 1201 provided at the left end of the list is clicked, the details of the measurement curve are displayed on the measurement information display screen (see FIG. 16). When a save button 1202 is clicked, a file save screen (not shown) is displayed, a file format such as csv is designated, and the retrieval result list is saved.

FIGS. 13A and 13B are examples of the retrieval result list screen 1020 that displays a list of retrieval results. As illustrated in FIGS. 13A and 13B, various functions can be added to the retrieval result list screen 1020. The retrieval result list screens 1020 illustrated in 13A and FIG. 13B are examples in which a similarity calculation function of shape feature vectors is added.

As the similarity, a norm distance between the shape feature vector of an input measurement curve and the shape feature vector of a retrieved measurement curve may be used. In addition, the similarity can be calculated by weighting a vector component of interest. FIG. 13A shows a retrieval result list before similarity calculation. A row 1301 for setting the weight of the vector component is provided, and the weight is set. A component whose weight is set to 0 is not used for norm distance calculation. When a normalize button 1302A is clicked, normalization of each vector component and calculation of the norm distance are executed, and the screen is switched to the screen in FIG. 13B.

The normalized vector component and the norm distance are displayed. A sort button 1303 is provided in each column, and when the sort button of the norm distance is clicked, the norm distances are sorted in ascending order. Further, the sort button of each vector component can be used for checking an abnormal value. When the user wants to return to the setting of weighting, the user clicks a measurement value button 1302B and returns to the screen in FIG. 13A.

The measurement record screen 1030 showing the measurement curves, the measured physical property values, and the measurement data characteristic information shown in FIG. 14 is provided with a display area 1410 of the measurement curve and the differential measurement curve, and a display area 1420 of the thermal characteristic property. In the display area 1420 of the thermal characteristic property, the thermophysical property, the substance, the physical property value, and the interpretation associated with the measurement curve are all displayed. For example, although only the peak temperature is shown in the list display, a peak area (melting entropy), a start temperature and an end temperature of a peak, and the interpretation of the peak are displayed if registered. The peaks and steps are assigned IDs, and positions of the peaks and steps are indicated by arrows 1403 in the graph area.

When the melting entropy is calculated as the total value of a plurality of peaks, the calculated value of the melting entropy is displayed in the row of the main peak, and the IDs of the plurality of peaks used for the calculation are displayed in an interpretation field (1404).

When the shape feature vector is selected for the retrieval condition, the input measurement curve (dotted line) and the retrieved measurement curve (solid line) are displayed in the display area 1410 of the measurement curve and the differential measurement curve. When an analysis example display button 1405 at the bottom of the screen is clicked, the analysis example display screen 1041 (see FIG. 15) including the measurement curve is displayed on another screen, when a measurement information display button 1406 is clicked, the measurement information display screen 1042 (see FIG. 16) is displayed on another screen, and when a calculation condition display button 1407 is clicked, the calculation information display screen 1043 (see FIG. 17) is displayed on another screen.

In the example of the analysis example display screen 1041 illustrated in FIG. 15, an analysis example title 1501, an analysis example graph 1502, a graph description 1503, and an analysis example interpretation 1504 are displayed. The analysis example graph 1502 displays a plurality of measurement curves including the selected measurement curve. The analysis example interpretation 1504 displays an interpretation obtained by comparing the plurality of measurement curves. When it is desired to know more detailed information regarding the analysis example, a document reference button 1505 is clicked, and a handbook describing the analysis example is displayed.

In the example of the measurement information display screen 1042 shown in FIG. 16, a measurement device property display area 1601 and a measurement condition property display area 1602 are provided. Examples of the property of the measurement device that affects the DSC measurement include the type of a device used (device manufacturer, device model number, analysis mode, etc.), the type of a sample pan, and the material and mass of a reference sample. In the measurement device property display area 1601, the properties are displayed in a table format.

In the measurement condition property display area 1602, a heat pattern, a gas type, and the like are displayed. The heat pattern is displayed not only in a table but also in a graph. In the case of thermal analysis, since the measurement curve changes depending on a thermal history of the sample, it is necessary to set not only the heat pattern when the measurement curve is measured but also the heat pattern before the measurement.

As the heat pattern, after a first temperature rise (run 1) and a temperature decrease (run 2), a second temperature rise (run 3) and a temperature decrease (run 4) are set, and all the runs are displayed. When the run from which the measurement curve is obtained is the run 3, the portion of the run 3 is displayed by a bold line 1603 and thick letters 1604. Several patterns such as ramp (inclination), step, and single frequency vibration are set as the heat pattern. When the pattern is ramp, a start temperature, an end temperature, a temperature change rate, a holding time, and the like are displayed.

The user confirms the measurement device property and the measurement condition property, and after modifying the measurement device property and the measurement condition property if necessary, saves the measurement information. When a save button 1605 is clicked, a file save screen (not shown) is displayed. A file format is designated, and measurement conditions are stored. If the format of a measurement condition setting file of the measurement device is supported, storage is executed in that format, and if not supported, storage is executed in a general-purpose format such as a csv format.

In the example of the calculation information display screen 1043 illustrated in FIG. 17, a display area 1701 of a measurement curve and a differential measurement curve and a display area 1702 of a calculation condition and a calculation result are provided. In DSC, it is necessary to set a base line type, a start point, an end point, and the like. In the display area 1701 of the measurement curve and the differential measurement curve, positions of the start point and the end point of a base line are indicated by +marks 1703, and a base line 1704 is indicated by a line segment or a curve. In the display area 1702 of the calculation condition and the calculation result, the calculation result is displayed together with the base line type, the start point, and the end point. In order to identify the peak or step with which the calculation condition is set, an ID is assigned to the peak or step and displayed in a graph and a table. The user confirms the calculation condition and the calculation result and saves the calculation condition. When a save button 1705 is clicked, a file save screen (not shown) is displayed. A file format is designated and calculation conditions are stored. If the format of a calculation condition setting file of analysis software of the measurement curve is supported, storage is executed in that format, and if not supported, storage is executed in a general-purpose format such as a csv format. The user refers to the output csv file to set calculation conditions of the analysis software, and executes calculation of thermophysical properties.

### Effects of Invention

As described above, the processing unit 12 (the retrieval unit 121) acquires the substance information retrieval condition including at least one of the substance specifying information, the measurement data, the information included in the measurement method of the measurement data, the information included in the measurement condition of the measurement data, the information included in the measurement data characteristic information, and the information included in the physical property information of the substance. Then, the processing unit 12 (the retrieval unit 121) can acquire and output the physical property case example information satisfying the substance information retrieval condition from the substance information database 231. The physical property case example information includes at least one piece of measurement record information of a set of measurement data of a substance and information on a measurement condition, and includes the measurement data characteristic information indicating a characteristic of the measurement data, and the physical property information calculated based on the measurement data.

Accordingly, the measurement data, the measurement condition, and the characteristic of the measurement data, which are stored in the substance information database, can be easily used. Accordingly, the physical property information retrieval system 1 (the physical property information retrieval method and the physical property information retrieval program) facilitates the collection of information on measurement of a substance measured in the past, which is referred to for determination of a measurement condition and interpretation of measurement data.

Further, the physical property information retrieval system 1 facilitates examination of a measurement condition of a substance and analysis of a property of the substance as in the following 1 to 3. 1. The measurement data, the measurement conditions, and the characteristics of the measurement data of a substance similar to a sample to be measured are acquired from the substance information database, and the measurement conditions for the sample to be measured can be examined. By examining in this manner, for example, it is easy to determine an appropriate measurement condition for a sample to be measured. 2. It is easy to acquire the measurement data measured in the past from the substance information database and verify the measurement data measured in the past. 3. By comparing the measurement data, the measurement conditions, and the characteristics of the measurement data between a plurality of substances, it is easy to find characteristics common to the plurality of substances and characteristics not common to the plurality of substances.

In addition, the physical property information retrieval system 1 (the physical property information retrieval method and the physical property information retrieval program) can restrict global warming by reducing energy necessary for the examination of the measurement condition of the substance and the analysis of the property of the substance and the emission amount of the generated carbon dioxide.

The measurement data characteristic information includes information of a set of a peak position specifying a peak, a protrusion degree of the peak, and a width of the peak, regarding a measurement curve created by plotting contiguous measurement data for the substance. Since the information does not depend on the interpretation of the measurement data, characteristics of a shape of the measurement data are clearly represented. As a result, the user can easily acquire desired measurement data.

The measurement data characteristic information includes information of a set of a peak position specifying a peak, a protrusion degree of the peak, and a width of the peak, regarding a differential measurement curve obtained by differentiating a measurement curve created by plotting contiguous measurement data for the substance. Since the information does not depend on the interpretation of the measurement data, characteristics of a shape of the measurement data are clearly represented. As a result, the user can easily acquire desired measurement data.

The data registration unit 122 generates physical property case example information knowledge graph information in which a template of the physical property case example information is converted into the knowledge graph format, outputs the physical property case example information knowledge graph information to the user terminal 500 and the measurement control device 610, and when physical property case example information created based on the physical property case example information knowledge graph information is acquired, stores the acquired physical property case example information created based on the physical property case example information knowledge graph information in the substance information database 231.

Here, since the information to be stored in the substance information database 231 is input using the template of the physical property case example information (the classes in FIGS. 4 to 9) represented in the knowledge graph format, it is easy to grasp the information to be stored in the substance information database 231 during the input process. Accordingly, the physical property information retrieval system 1 facilitates the input of information to be stored in the substance information database 231.

The physical property information retrieval system 1 can be constructed in a server in a cloud environment. In this case, it is easy to construct the physical property information retrieval system 1.

In addition, the physical property information retrieval system 1 can be constructed in a server in an on-premise environment. In this case, maintenance of the physical property information retrieval system 1 is facilitated.

Some or all of the configurations, functions, processing units, processing methods, and the like described above may be implemented by hardware by, for example, designing with an integrated circuit. The invention can also be implemented by a program code of software for implementing the functions in the embodiments. In this case, a storage medium storing the program code is provided to a computer, and a processor provided in the computer reads the program code stored in the storage medium. In this case, the program code read from the storage medium implements the functions of the embodiments described above by itself, and the program code itself and the storage medium storing the program code constitute the invention. Examples of the storage medium for supplying such a program code include a flexible disk, a CD-ROM, a DVD-ROM, a hard disk, a solid state drive (SSD), an optical disk, a magneto-optical disk, a CD-R, a magnetic tape, a nonvolatile memory card, and a ROM.

Further, the program code for implementing the functions described in the embodiments can be implemented in a wide range of programs or script languages such as assembler, C/C++, Perl, Shell, PHP, Python, and Java (registered trademark).

Further, the program code of the software for implementing the functions in the embodiments may be distributed via a network to be stored in a storage unit such as a hard disk or a memory of a computer or a storage medium such as a CD-RW or a CD-R, and a processor provided in the computer may read and execute the program code stored in the storage unit or the storage medium.

Control lines and information lines considered to be necessary for description are illustrated in the embodiments described above, and not all control lines and information lines in a product are necessarily illustrated. All the configurations may be connected to one another.

### REFERENCE SIGNS LIST

1: physical property information retrieval system
11: transmission and reception unit
12: processing unit
121: retrieval unit
121a: retrieval program
122: data registration unit
122a: data registration program
21: processor
22: main storage device
23: sub-storage device
231: substance information database
232: physical property case example database
24: input device
25: output device
26: network I/F
27: bus
500: user terminal
600: measurement device
610: measurement control device
NW: network

1. A physical property information retrieval system that includes a processor and a storage device storing a substance information database storing information on a substance and, when a retrieval condition related to the substance is acquired, acquires information satisfying the retrieval condition related to the substance from the substance information database and outputs the acquired information satisfying the retrieval condition, the physical property information retrieval system comprising:
a processing unit; and
a transmission and reception unit configured to transmit and receive data, wherein
the substance information database stores physical property case example information in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data, and
when the transmission and reception unit acquires substance information retrieval condition including at least one of the substance specifying information, the measurement data, information included in the information on the measurement condition of the measurement data, information included in the measured physical property value, and information included in the physical property specifying information, the processing unit retrieves the substance information database to acquire substance case example information satisfying the substance information retrieval condition, and causes the transmission and reception unit to output the substance case example information satisfying the substance information retrieval condition acquired by the processing unit.

2. The physical property information retrieval system according to claim 1, wherein
the measurement data characteristic information includes information of a set of a peak position specifying a peak, a protrusion degree of the peak, and a width of the peak regarding a measurement curve created by plotting the contiguous measurement data for the substance.

3. The physical property information retrieval system according to claim 1, wherein
the measurement data characteristic information includes information of a set of a peak position specifying a peak, a protrusion degree of the peak, and a width of the peak regarding a differential measurement curve obtained by differentiating a measurement curve created by plotting the contiguous measurement data for the substance.

4. The physical property information retrieval system according to claim 1, further comprising:
a data registration unit, wherein
the data registration unit
generates physical property case example information knowledge graph information in which a template of the physical property case example information is converted into a knowledge graph format,
outputs the physical property case example information knowledge graph information, and
when physical property case example information created based on the physical property case example information knowledge graph information is acquired, stores the acquired physical property case example information created based on the physical property case example information knowledge graph information in the substance information database.

5. The physical property information retrieval system according to claim 1, wherein
the physical property information retrieval system is constructed in a server in a cloud environment.

6. The physical property information retrieval system according to claim 1, wherein
the physical property information retrieval system is constructed in a server in an on-premise environment.

7. A physical property information retrieval method for a physical property information retrieval system that includes a processor and a storage device storing a substance information database storing information on a substance and, when a retrieval condition related to the substance is acquired, acquires information satisfying the retrieval condition related to the substance from the substance information database and outputs the acquired information satisfying the retrieval condition, wherein
the substance information database stores physical property case example information in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data, and
when a substance information retrieval condition including at least one of the substance specifying information, the measurement data, information included in the information on the measurement condition of the measurement data, information included in the measured physical property value, and information included in the physical property specifying information is acquired, the processor retrieves from the substance information database substance case example information satisfying the substance information retrieval condition, and outputs the retrieved substance case example information satisfying the substance information retrieval condition.

8. A non-transitory computer-readable storage medium storing a physical property information retrieval program, wherein the physical property information retrieval program is configured to cause a processor in a physical property information retrieval system that includes a processor and a storage device storing a substance information database storing information on a substance to execute the steps of:
when a retrieval condition related to the substance is acquired, acquiring information satisfying the retrieval condition related to the substance from the substance information database and outputting the acquired information satisfying the retrieval condition, including
storing physical property case example information in the substance information database in which substance specifying information specifying the substance is associated with at least one piece of measurement record information that is information of a set of contiguous measurement data for the substance, information on a measurement condition of the measurement data, a measured physical property value calculated based on the measurement data, and measurement data characteristic information indicating a characteristic of the measurement data,
when the physical property information retrieval system acquires a substance information retrieval condition including at least one of the substance specifying information, the measurement data, information included in the information on the measurement condition of the measurement data, information included in the measured physical property value, and information included in the physical property specifying information, retrieving from the substance information database substance case example information satisfying the substance information retrieval condition, and
outputting the retrieved substance case example information satisfying the substance information retrieval condition.
